(19) United States
(12) Patent Application Publication
(10) Pub. No.: US 2008/0252595 A1
(43) Pub. Date: Oct. 16, 2008

(54) Method and Device for Virtual Navigation and Voice Processing

(76) Inventor: Marc Boillot, Plantation, FL (US)

Correspondence Address: Marc Boillot, 9110 NW 11th Court, Plantation, FL, 33322, US

(21) Appl. No.: 12/099,662

(22) Filed: Apr. 8, 2008

Related U.S. Application Data
(60) Provisional application No. 60/911,082, filed on Apr. 11, 2007.

(51) Int. Cl. G09G 5/00; H04R 29/00; H04R 5/027

(52) U.S. Cl. 345/156; 381/56; 381/92; 704/251; 381/110

(57) ABSTRACT

An apparatus for virtual navigation and voice processing is provided. A system that incorporates teachings of the present disclosure may include, for example, a computer readable storage medium having computer instructions for processing voice signals captured from a microphone array, detecting a location of an object in a touchless sensory field of the microphone array, and receiving information from a user interface in accordance with the location and voice signals.

### CROSS-REFERENCE TO RELATED APPLICATION

This application incorporates by reference the following Utility Applications: U.S. patent application Ser. No. 11683410 Attorney Docket No. B00.11 entitled “Method and System for Three-Dimensional Sensing” filed on Mar. 7, 2007 claiming priority on U.S. Provisional Application No. 60/779,868 filed Mar. 8, 2006, and U.S. patent application Ser. No. 11683415 Attorney Docket No. B00.14 entitled “Sensory User Interface” filed on Mar. 7, 2007 claiming priority on U.S. Patent Application No. 60/781,179 filed on Mar. 13, 2006.

### FIELD

The present embodiments of the invention generally relate to the field of acoustic signal processing, more particularly to an apparatus for directional voice processing and virtual navigation.

### BACKGROUND

A mobile device and computer are known to expose graphical user interfaces. The mobile device or computer can include a peripheral accessory such as a keyboard, mouse, touchpad, touch-screen, or stick for controlling components of the user interface. A user can navigate the graphical user interface by physical touching or handling of the peripheral accessory to control an application.

As mobile devices decrease in size, the area of the user interface generally decreases. For instance, the size of a graphical user interface on a touch-screen is limited to the physical dimensions of the touch-screen. Moreover, as applications become more sophisticated the number of user interface controls in the user interface may increase. A graphical user interface on a small display can present only a few user interface components. The number of user interface controls is generally a function of the size of the physical interface and the resolution of physical control.

A need therefore exists for expanding a user interface area from a limited size of a physical device.

### BRIEF DESCRIPTION OF THE DRAWINGS

The features of the embodiments of the invention, which are believed to be novel, are set forth with particularity in the appended claims. Embodiments of the invention, together with further objects and advantages thereof, may best be understood by reference to the following description, taken in conjunction with the accompanying drawings, in the several figures of which like reference numerals identify like elements, and in which:

FIG. 1 is an exemplary sensory device that recognizes touchless finger movements and detects voice signals in accordance with one embodiment;

FIG. 2 is an exemplary embodiment of the sensory device in accordance with one embodiment;

FIG. 3 is an exemplary diagram of a communication system in accordance with one embodiment;

FIG. 4 is an exemplary user interface for presenting location based information in accordance with one embodiment;

FIG. 5 is an exemplary user interface for presenting advertisement information in accordance with one embodiment;

FIG. 6 is an exemplary user interface for presenting contact information in accordance with one embodiment;

FIG. 7 is an exemplary user interface for controlling a media player in accordance with one embodiment;

FIG. 8 is an exemplary user interface for adjusting controls in accordance with one embodiment;

FIG. 9 is an exemplary user interface for searching media in accordance with one embodiment; and

FIG. 10 depicts an exemplary diagrammatic representation of a machine in the form of a computer system within which a set of instructions, when executed, may cause the machine to perform any one or more of the methodologies disclosed herein.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a midlet, a source code, an object code, a shared library/dynamic load library and/or other sequence of instructions designed for execution on a computer system.

In a first embodiment, a microphone array device can include at least two microphones, and a controller element communicatively coupled to the at least two microphones. The controller element can track a finger movement in a touchless sensory field of the at least two microphones, process a voice signal associated with the finger movement, and communicate a first control of a user interface responsive to the finger movement and a second control of the user interface responsive to the voice signal. The controller element can associate the finger movement with a component in the user interface, and inform the user interface to present information associated with the component in response to the voice signal. The information can be audible, visual, or tactile feedback. The information can be an advertisement, a search result, a multimedia selection, an address, or a contact.

The controller element can identify a location of the finger in the touchless sensory field, and in response to recognizing the voice signal, generate a user interface command associated with the location. The controller element can identify a location or movement of the finger in the touchless sensory field, associate the location or movement with a control of the user interface, acquire the control in response to a first voice signal, adjust the at least one control in accordance with a second finger movement, and release the control in response to a second voice signal. The controller element can also identify a location or movement of a finger in the touchless sensory field, acquire a control of the user interface according to the location or movement, adjust the control in accordance with a voice signal, and release the control in responsive to identifying a second location or movement of the finger.

The voice signal can increase the control, decrease the control, cancel the control, select an item, de-select the item, copy the item, paste the item, or move the item. The voice signal can be a spoken ‘accept’, ‘reject’, ‘yes’, ‘no’, ‘cancel’, ‘back’, ‘next’, ‘increase’, ‘decrease’, ‘up’, ‘down’, ‘stop’, ‘play’, ‘pause’, ‘copy’, ‘cut’, or ‘paste’. The microphone array can include at least one transmitting element that transmits an ultrasonic signal. The controller element can identify the finger movement from a relative phase and time of flight of a reflection of the ultrasonic pulse off the finger.

In a second embodiment a storage medium can include computer instructions for a method of tracking a finger movement in a touchless sensory field of a microphone array, processing a voice signal received at the microphone array associated with the finger movement, navigating a user interface in accordance with the finger movement and the voice signal, and presenting information in the user interface according to the finger movement and the voice signal. The storage medium can include computer instructions for detecting a direction of the voice signal, and adjusting a directional sensitivity of the microphone array with respect to the direction.

The storage medium can include computer instructions for detecting a finger movement in the touchless sensory field, and controlling at least one component of the user interface in accordance with the finger movement and the voice signal. Computer instructions for activating a component of the user interface selected by the finger movement, and adjusting the component in response to a voice signal can also be provided. The storage medium can include computer instructions for overlaying a pointer in the user interface, controlling a movement of the pointer in accordance with finger movements, and presenting the information when the pointer is over an item in the display. Information can be overlayed on the user interface when the finger is at a location in the touchless sensory space that is mapped to a component in the user interface.

In a third embodiment a sensing unit can include a transmitter to transmit ultrasonic signals for creating a touchless sensing field, a microphone array to capture voice signals and reflected ultrasonic signals, and a controller operatively coupled to the transmitter and microphone array. The controller can process the voice signals and ultrasonic signals, and adjust at least one user interface control according to the voice signals and reflected ultrasonic signals. The controller element can identify a location of an object in the touchless sensory field, and adjust a directional sensitivity of the microphone array to the location of the object. The controller element can identify a location of a finger in the touchless sensory field, map the location to a sound source, and suppress or amplify acoustic signals from the sound source that are received at the microphone array. The controller can determine from the location when the sensing unit is hand-held for speaker-phone mode and when the sensing unit is held in an ear-piece mode. The sensing unit can be communicatively coupled to a cell phone, a headset, a portable music player, a laptop, or a computer.

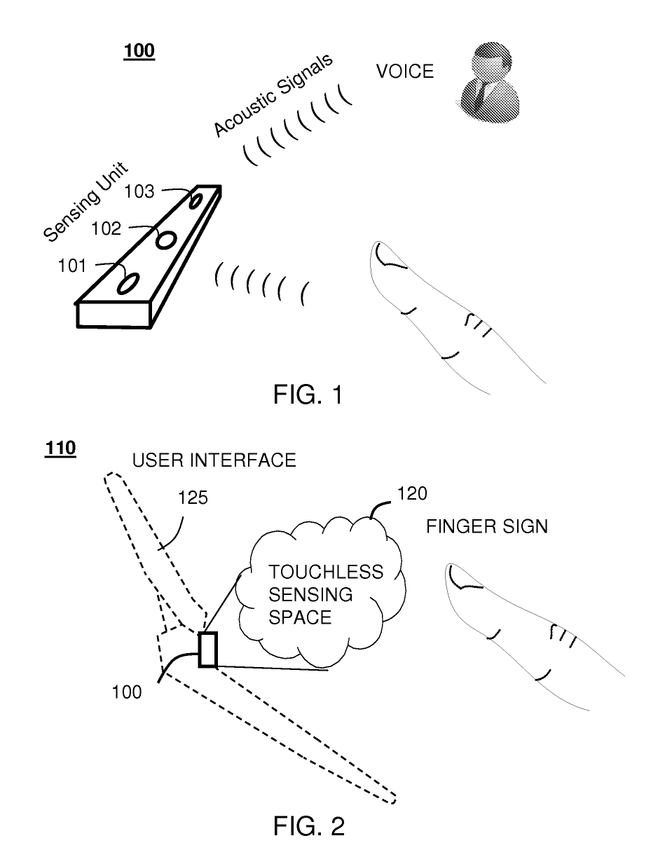

Referring to FIG. 1, a sensing unit 110 is shown. The sensing unit 100 can include a microphone array with at least two microphones (e.g. receivers 101 and 103). The microphones are wideband microphones that can capture acoustic signals in the approximate range of 20 Hz to 40 KHz, and also ultrasonic signals at 40 KHz up to 200 KHz. The microphones can be tuned to the voice band range between 100 z (low band voice) and 20 KHz. In one aspect, the microphones are sensitive to acoustic signals within the voice band range, and have a variable signal gain between 3 dB and 40 dB but is not limited to these ranges. The frequency spectrum of the microphone array in the voice band region can be approximately flat, tuned to a sensitivity of human hearing, or tuned to an audio equalization style such as soft-voice, whisper voice, dispatch voice (e.g. hand-held distance), ear-piece voice (e.g. close range) jazz, rock, classical, or pop. The microphones can also be tuned in a band-pass configuration for a specific ultrasonic frequency. For example, in one configuration, the microphones (102 and 103) have a narrow-band Q function for 40 KHz ultrasonic signals. The microphones can also be manufactured for 80 KHz and 120 KHz or other ultrasonic narrowband or wideband frequencies. Notably, the microphones have both a low-frequency wide bandwidth for voice signals (e.g. 20 Hz to 20 KHz), and a high-frequency narrow bandwidth (e.g. 39-41 KHz) for ultrasonic signals. That is, the microphone array can detect both voice signals and ultrasonic signals using the same microphone elements.

The sensing device 100 also includes at least one ultrasonic transmitter 102 that emits a high energy ultrasonic signal, such as a pulse. The pulse can include amplitude, phase, and frequency modulation as in U.S. patent application Ser. No. 11/562,410 herein incorporated by reference. The transmitter 102 can be arranged in the center configuration shown or in other configurations that may be along a same principal axis of the receivers 101 and 103, or in another configuration along different axes, with multiple transmitters and receivers. For example, the elements of the microphone array (101-103) may be arranged in a square shape, L shape, in-line shape, or circular shape. The sensing device 100 includes a controller element that can detect a location of an object, such as a finger, within a touchless sensing field of the microphone array using pulse-echo range detection techniques, for example, as presented in U.S. Patent Application No. 60/837,685 herein incorporated by reference. For instance, the controller element can estimate a time of flight (TOF) or differential TOF between a time a pulse was transmitted and when a reflection of the pulse off the finger is received. The sensing device 100 can estimate a location and movement of the finger in the touchless sensing field, for example, as presented in U.S. Patent Application No. 60/839,742 and No. 60/842,436 herein incorporated by reference.

The sensing device 100 can also determine a location of a person speaking using adaptive beam-forming techniques and other time-delay detection algorithms. In a first configuration, the sensing device 100 uses the microphone elements (e.g. receivers 101 and 103) to capture acoustic voice signals emanating directly from the person speaking. In such regard, the sensing element maximizes a sensitivity of the microphone array to a direction of the voice signals from the person talking. In a second configuration the sensing unit 100 can adapt a directional sensitivity of the microphone array based on a location of an object, such as a finger. For example, the user can position the finger at a location, and the sensing unit can detect the location, and adjusts the directional sensitivity of the microphone array to the location of the finger.

Notably, the sensing unit 100 can adjust the directional sensitivity to either the person speaking or to an object such as a finger. The sensing unit can use a beam forming algorithm to detect the originating direction of the voice signals, use pulse-echo location to identify a location of a person generating the voice signals, and adjust the directional sensitivity of the microphone array in accordance with the originating direction and location of the person. A user can also adjust the directivity using a finger for introducing audio effects such as panning or balance in an audio signal while speaking. In one embodiment, the user can position the finger in a location of the touchless sensing field corresponding to an approximate direction of an incoming sound source. The sensing unit can map the location to the direction, and attenuate or amplify sounds arriving from that direction.

FIG. 2 shows one exemplary embodiment of the sensing unit. As illustrated, the sensing unit 100 can be integrated within a mobile device such as a cell phone, for example, as presented in U.S. Patent Application No. 60/855,621, hereby incorporated by reference. The sensing device 100 can also be embodied within a portable music player, a laptop, a headset, an earpiece, a computer, or any other mobile communication device. When the sensing unit 100 is configured for ultrasonic sensing, a touchless sensing field 120 is generated above the mobile device 110. A user can hold a finger in the touchless sensing field 120, and control a user interface component in a user interface 125 of the mobile device. For example, the user can perform a touchless finger circular action to adjust a volume control, or scroll through a list of contacts presented in the user interface via touchless finger movements.

The sensing unit 100 can also receive and process voice signals presented by the user. In one arrangement, the user can position the finger within the touchless sensing field 120 to adjust a directional sensitivity of the microphone array to an origination direction. For example, the user may center the finger at a location above the mobile device, to indicate that the directional sensitivity be directed to the location, where the user may be speaking and originating the voice signal. When two users are both speaking in a conference call situation and using the same phone, a user can point in a direction of the user that is speaking to increase the voice signal reception.

In another arrangement, the user can point in a direction of a noise source, and the sensing device can direct the sensitivity away from the noise source to suppress the noise. Furthermore, the sensing device can detect a location of the person, such as the person's chin, which is closest in proximity to the microphone array when the person is speaking into the mobile device, and direct the sensitivity to the direction of the chin. The microphone array can increase a sensitivity for receiving voice signals arriving from the user's mouth. In such regard, the sensing unit 110 can determine when the mobile device is held in a hand-held speaker phone mode and when the mobile device is held in an ear-piece mode.

The mobile device 110 can include a keypad with depressible or touch sensitive navigation disk and keys for manipulating operations of the mobile device. The mobile device 110 can further include a display such as monochrome or color LCD (Liquid Crystal Display) for presenting the user interface 125, conveying images to the end user of the terminal device, and an audio system that utilizes common audio technology for conveying and intercepting audible signals of the end user. The mobile device 110 can include a location receiver that utilizes common technology such as a common GPS (Global Positioning System) receiver to intercept satellite signals and therefrom determine a location fix of the mobile device 110. A controller of the mobile device 110 can utilize computing technologies such as a microprocessor and/or digital signal processor (DSP) with associated storage memory such a Flash, ROM, RAM, SRAM, DRAM or other like technologies for controlling operations of the aforementioned components of the mobile device.

In a wireless communications setting, a transceiver of the mobile device 110 can utilize common technologies to support singly or in combination any number of wireless access technologies including without limitation cordless phone technology (e.g., DECT), Bluetooth™, Wireless Fidelity (WiFi), Worldwide Interoperability for Microwave Access (WiMAX), Ultra Wide Band (UWB), software defined radio (SDR), and cellular access technologies such as CDMA-1X, W-CDMA/HSDPA, GSM/GPRS, TDMA/EDGE, and EVDO. SDR can be utilized for accessing a public or private communication spectrum according to any number of communication protocols that can be dynamically downloaded over-the-air to the terminal device. It should be noted also that next generation wireless access technologies can be applied to the present disclosure.

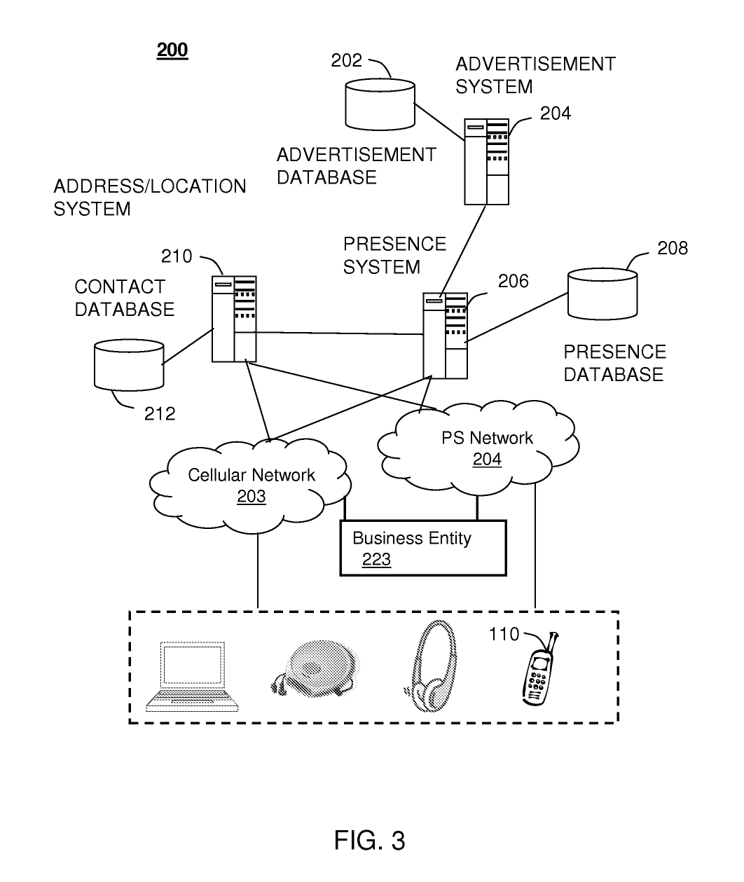

FIG. 3 shows a communication system 200 in accordance with an embodiment. The communication system 100 can include an advertisement system 204, with a corresponding advertisement database 202, a presence system 206, with a corresponding presence database 208, an address system 210 with a corresponding contact database 210, and a cellular infrastructure component 220 having connectivity to one or more mobile devices 110. The communication system 100 can include a circuit-switched network 203 and a packet switched (PS) network 204. The mobile device 110 of the communication system 100 can utilize common computing and communications technologies to support circuit-switched and/or packet-switched communications. The communication system 100 is not limited to the components shown and can include more or less than the number of components shown.

The communications system 200 can offer mobile devices 110 Internet and/or traditional voice services such as, for example, POTS (Plain Old Telephone Service), VoIP (Voice over Internet communications, broadband communications, cellular telephony, as well as other known or next generation access technologies. The PS network 203 can utilize common technology such as MPLS (Multi-Protocol Label Switching), TCP/IP (Transmission Control Protocol), and/or ATM/FR (Asynchronous Transfer Mode/Frame Relay) for transporting Internet traffic. In an enterprise setting, a business enter price can interface to the PS network 203 by way of a PBX or other common interfaces such xDSL, Cable, or satellite. The PS network 203 can provide voice, data, and/or video connectivity services between mobile devices 110 of enterprise personnel such as a POTS (Plain Old Telephone Service) phone terminal, a Voice over IP (VoIP) phone terminal, or video phone terminal.

The presence system 206 can be utilized to track the location and status of a party communicating with one or more of the mobile devices 110 or business entities 223 in the communications system 200. Presence information derived from a presence system 206 can include a location of a party utilizing a mobile device 110, the type of device used by the party (e.g., cell phone, PDA, home phone, home computer, etc.), and/or a status of the party (e.g., busy, offline, actively on a call, actively engaged in instant messaging, etc.). The presence system 206 performs the operations for parties who are subscribed to services of the presence system 206. The presence system 206 can also provide information, such as contact information for the business entity 223 from the address system 210 or advertisements for the business entity 223 in the advertisement system 204, to the mobile devices 110.

The address system 210 can identify an address of a business entity and include contact information for the business entity. The location system can process location requests seeking an address of the business entity 223. The address system 210 can also generate directions, or a map, to an address corresponding to the business entity or to other businesses in a vicinity of the location. The advertisement system 204 can store advertisements associated with, or provided by, the business entity 223. The address system 210 and the advertisement system 204 can operate together to provide advertisements of the business entity 223 to the mobile device 110.

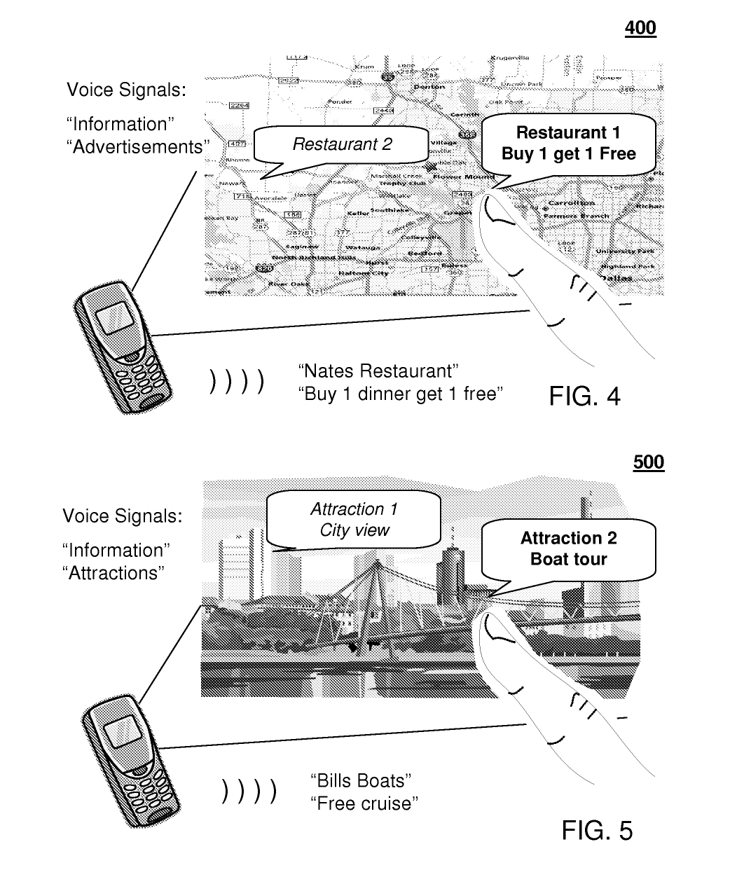

Referring to FIG. 4, an exemplary user interface 400 for presenting location based information in response to touchless finger movements and voice signals is illustrated. The sensing unit 100 associates a location of the finger with an entry in the user interface 400, and presents information associated with the entry according to the location. The information can provide at least one of an audible, visual, or tactile feedback. As an example, as shown in FIG. 4, the user can point to a location on a displayed map, and the sensing device can associate the location of the finger with an entity on the map, such as a business. Referring back to FIG. 3, the address system 210 can determine a location of the business entity, and the advertisement system 204 can provide advertisements associated with the location. The mobile device 110 can present the advertisements associated with the entity at the location of the finger. In such regard, a user can point to different areas on the map and receive pop-up advertisements associated with the entity. For instance, the pop-up may identify the location as corresponding to a restaurant with a special dinner offer. The pop-ups may stay for a certain amount of time while the finger moves, and then slowly fade out over time. The user may also move the finger in and out of the touchless sensory field 120 to adjust a zoom of the map.

In one arrangement, the sensing unit 100 detects a location of the finger in a touchless sensory field of the microphone array, and asserts a control of the user interface 400 according to the location in response to recognizing a voice signal. For example, upon the user presenting the finger over a location on the map, the user can say “information” or “advertisements” or any other voice signal that is presented as a voice signal instruction on the user display. The mobile device can audibly play the information or advertisements associated with the entity at the location.

Referring to FIG. 5, an exemplary user interface 500 for presenting advertisement information in response to touchless finger movements and voice signals is illustrated. The advertisement information can be an advertisement, a search result, a multimedia selection, an address, and a contact. For example, the user may download an image, or a map of a particular region, city, amusement park, shopping basket, virtual store, location, game canvas, or virtual guide. The user can point with the finger to certain objects in the image or map. The sensing unit 100 can identify a location of the finger with the object in the image. The advertisement server can provide advertisements related to the object in the image, such as a discount value. In another example, the image can show products for sale in a virtual store. The user can navigate through the products in the image using three dimensional finger movement. For example, the user can move the finger forward or backward above the image to navigate into or out of the store, and move the finger left, right, up, or down, to select products. The advertisement system 204 can present price lists for the items, product ratings, satisfaction ratings, back order status, and discounts for the products. In the illustration shown, the user can point to object in the image that offer services, such as a ticketing service.

In one arrangement, the user can point to an item in the image, and then speak a voice signal such as “information” or “attractions” for receiving audible, visual, or tacticle feedback. More specifically, the sensing unit 100 processes voice signals captured from the microphone array, detects a location of an object in a touchless sensory field of the microphone array, and receives information from the user interface in accordance with the location and voice signals. The advertisement system 204 receives position information from the sensing unit, and provides item information associated with the item identified by the position information to the mobile device. The advertisement system 204 provides advertisement information associated with items in the user interface identified by the positioning of the finger in response to a voice signal. The advertisement system 204 can present additional item information about the item in response to a touchless finger movement or a voice command. For example, the user can issue an up/down movement to expand a list of information provided with the item.

Furthermore, the advertisement system 204 can receive presence information from the presence system 206 and filter the item information based on the presence information. For example, the user can upload buying preferences in a personal profile to the presents system 206 identifying items or services desired by the user. Instead of the advertisement system 204 presenting all the information available to an item that is pointed to, the advertisement system 204 can filter the information to only present the information presented in the user preferences. In such regard, as the user moves their finger over different items in the image, the advertisement system 204 presents only information of interest to the user that is specified for presentation in the personal profile. This limits the amount of information that is presented to the user, and reduces the amount of spam advertisements presented as the user navigates through the image.

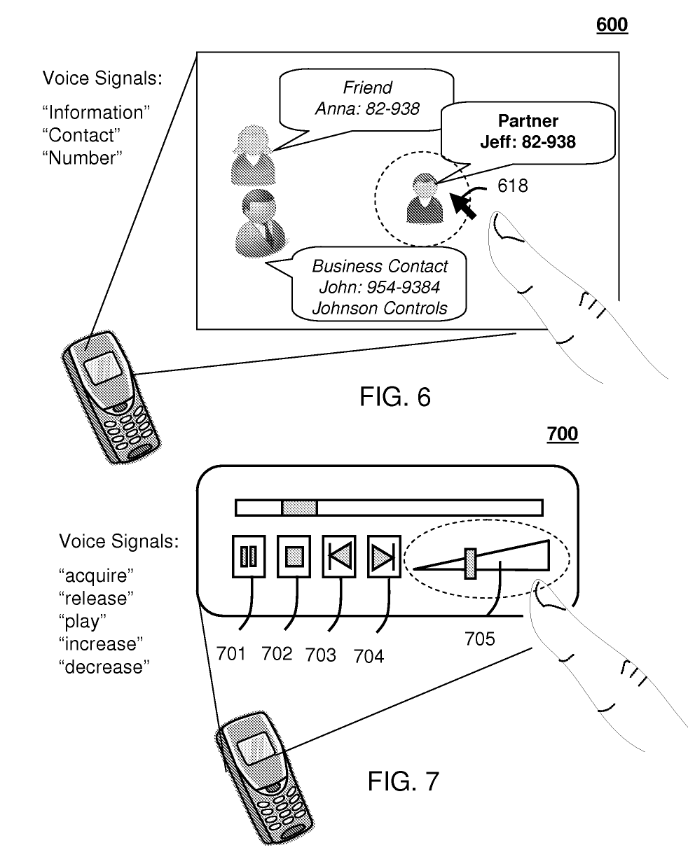

Referring to FIG. 6, an exemplary user interface 600 for presenting contact information in response to touchless finger movements and voice signals is illustrated. As one example, the user interface 600 can present avatars (e.g. animated characters) in a virtual setting that are either stationary, or that move around based on predetermined cycles (e.g. time of day, business contacts, children, vacation, school). As shown, the user interface is a contact list for business people in a meeting, wherein the people are arranged in physical order of appearance at the meeting. For example, each avatar may correlate with a location of a person at a conference table. The user can visualize the avatars on the user interface, and point to an avatar to retrieve contact information. For example, the user may point in the user interface to an avatar of a person across the table. The sensing unit 100 can identify the location of the finger with the avatar, and the user interface can respond with contact information for the person associated with the avatar. The contact information can identify a name of the person, a phone number, an email address, a business address or phone number, and any other contact related information. The mobile device can also overlay a pointer 618 in the user interface 600 to identify the object pointed to, control a movement of the pointer in accordance with finger movements, and present information when the pointer is over an item in the display.

Referring to FIG. 7, an exemplary user interface 700 for controlling a media player in response to touchless finger movements and voice commands is shown. As an example, a user can audibly say “media control” and the mobile device 110 can present the media player 700. The sensing unit 100 recognizes the voice signal and initiates touchless control of the user interface using the ultrasonic signals. The user can proceed to adjust a media control by positioning a finger over the media control. The sensing unit 100 detects a finger movement in the touchless sensory field 120, and adjusts at least one control of the user interface in accordance with the finger movement and the voice signals. In another arrangement, the sensing unit 100 element identifies the location of the finger in the touchless sensory field 120, associates the location with at least one control 705 of the user interface, acquires the control 705 in response to a first voice signal, adjusts the at least one control 705 in accordance with a finger movement, and releases the at least one control 705 in response to a second voice signal. For example, the user can position the finger over control 705, and say “acquire”. The user can then adjust the control by issuing touchless finger actions such as a circular scroll to increase the volume. The user can then say “release” to release the control. In another arrangement, the user can adjust the control 705 in accordance with a voice command. The voice signals available to the user can be presented or displayed in the user interface. Notably, many other voice signals, or voice commands, can be presented, or identified by the user for use. For example, the mobile device can include a speech recognition engine that allows a user to submit a word as a voice command. As one example, the user can position the finger over the control, such as the volume control, 705 and say “increase” or “decrease” to adjust the volume. The voice command voice command can increase the at least one control, decrease the at least one control, cancel the at least one control, select an item, de-select the item, copy the item, paste the item, and move the item.

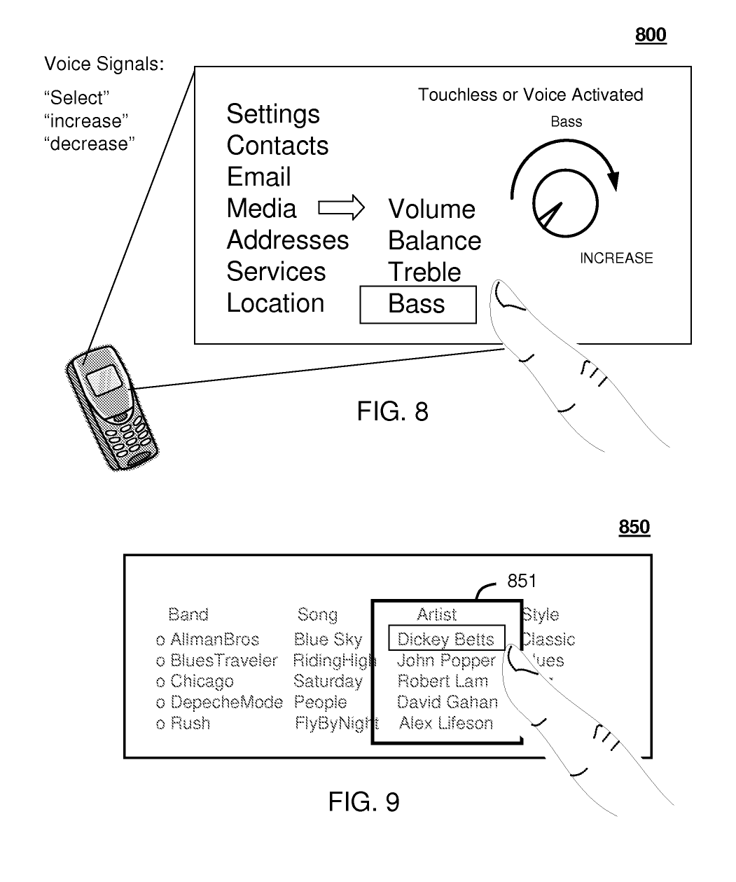

Referring to FIG. 8, an exemplary user interface 800 for adjusting controls in response to touchless finger movements and voice commands is shown. The user interface 800 can be an Interactive Voice Response (IVR) system, a multimedia searching system, an address list, an email list, a song list, a contact list, a settings panel, or any other user interface dialogue. In the illustration shown, the user can navigate through one or more menu items by pointing to the items. Notably, the user does not need to touch the user interface to select the menu item, since the sensing unit 100 can detect touchless finger movement in the touchless sensory field 120. The sensing unit 100 allow the user to navigate a menu system in accordance with a finger movement and a voice signal. The user can pre-select a menu item in the menu system in accordance with the finger movement, and select the menu item in response to a voice signal. For example, the user interface can high-light a menu item that is pointed to for pre-selecting the item, and the user can say “select” to select the menu item. Alternatively, the user can perform another finger directed action such as an up/down movement for selecting the menu item. The user interface 800 can overlay menu items to increase a visual space of the user interface in accordance with the finger movement. Moreover, the user interface 800 can increase a zoom size for menu items as they are selected and bring them to the foreground. As an example, the user can select ‘media’ then ‘bass’ to adjust a media control in the user interface 800 as shown. The user interface 800 can present a virtual dial that the user can adjust in accordance with touchless finger movements or voice commands. Upon adjusting the control, the user can confirm the settings by speaking a voice command. Recall, the microphone array in the sensing device 100 captures voice signals and ultrasonic signals, and the controller element processes the voice signals and ultrasonic signals to adjust at a user interface control in accordance with the ultrasonic signals.

Referring to FIG. 9, an exemplary user interface 850 for searching media in response to touchless finger movements and voice commands is shown. As illustrated, the user can point to a menu item, such as a song selection, and select a song by either holding the finger still at a pre-selected menu item, or speaking a voice signal, such as ‘yes’ for selecting the item. The voice signal can be a ‘yes’, ‘no’, ‘cancel’, ‘back’, ‘next, ‘increase’, ‘decrease’, ‘stop’, ‘play’, ‘pause’, ‘cut’, or ‘paste’. As another example, the user can point to an item 851, say ‘copy’ and then point the finger to a file folder, and say ‘paste’ to copy the song from a first location to a second location. The sensing unit 110 processes voice signals, detects a finger movement in a touchless sensory field of the sensing unit, and controls the user interface 850 in accordance with the finger movement and the voice signals.

From the foregoing descriptions, it would be evident to an artisan with ordinary skill in the art that the aforementioned embodiments can be modified, reduced, or enhanced without departing from the scope and spirit of the claims described below. Other suitable modifications can be applied to the present disclosure. Accordingly, the reader is directed to the claims for a fuller understanding of the breadth and scope of the present disclosure.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

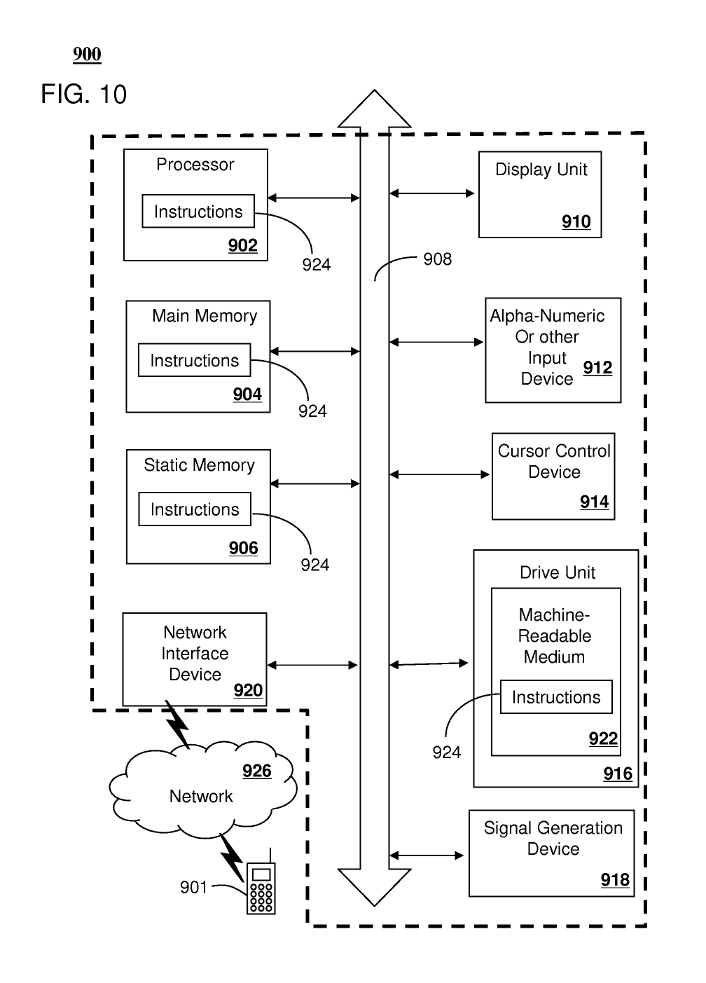

For example, FIG. 10 depicts an exemplary diagrammatic representation of a machine in the form of a computer system 900 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a mobile device, a laptop computer, a desktop computer, a control system, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 900 may include a processor 902 (e.g., a central processing unit (CPU), a graphics processing unit (GPU, or both), a main memory 904 and a static memory 906, which communicate with each other via a bus 908. The computer system 900 may further include a video display unit 910 (e.g., a liquid crystal display (LCD), a flat panel, a solid state display, or a cathode ray tube (CRT)). The computer system 900 may include an input device 912 (e.g., a keyboard, touch-screen), a cursor control device 914 (e.g., a mouse), a disk drive unit 916, a signal generation device 918 (e.g., a speaker or remote control) and a network interface device 920.

The disk drive unit 916 may include a machine-readable medium 922 on which is stored one or more sets of instructions (e.g., software 924) embodying any one or more of the methodologies or functions described herein, including those methods illustrated above. The instructions 924 may also reside, completely or at least partially, within the main memory 904, the static memory 906, and/or within the processor 902 during execution thereof by the computer system 900. The main memory 904 and the processor 902 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 924, or that which receives and executes instructions 924 from a propagated signal so that a device connected to a network environment 926 can send or receive voice, video or data, and to communicate over the network 926 using the instructions 924. The instructions 924 may further be transmitted or received over a network 926 via the network interface device 920 to another device 901.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

While the preferred embodiments of the invention have been illustrated and described, it will be clear that the embodiments are not so limited. Numerous modifications, changes, variations, substitutions and equivalents will occur to those skilled in the art without departing from the spirit and scope of the present embodiments of the invention as defined by the appended claims.

What is claimed is:

1. A microphone array device, comprising:
at least two microphones; and
a controller element communicatively coupled to the at least two microphones to
track a finger movement in a touchless sensory field of the at least two microphones;
process a voice signal associated with the finger movement; and
communicate a first control of a user interface responsive to the finger movement and a second control of the user interface responsive to the voice signal.

2. The microphone array device of claim 1, wherein the controller element
associates the finger movement with a component in the user interface, and
informs the user interface to present information associated with component in response to the voice signal,
where the information is audible, visual, or tactile feedback.

3. The microphone array device of claim 3, wherein the information is an advertisement, a search result, a multimedia selection, an address, or a contact.

4. The microphone array device of claim 1, wherein the controller element
identifies a location of the finger in the touchless sensory field, and
in response to recognizing the voice signal, generates a user interface command associated with the location.

5. The microphone array device of claim 1, wherein the controller element
identifies a location or movement of the finger in the touchless sensory field,
associates the location or movement with at least one control of the user interface,
acquires the at least one control in response to a first voice signal,
adjusts the at least one control in accordance with a second finger movement, and
releases the at least one control in response to a second voice signal.

6. The microphone array device of claim 1, wherein the controller element
identifies a location or movement of a finger in the touchless sensory field,
acquires a control of the user interface according to the location or movement,
adjusts the control in accordance with a voice signal, and
releases the control in responsive to identifying a second location or movement of the finger.

7. The microphone array device of claim 6, wherein the voice signal increases the control, decreases the control, cancels the control, selects an item, de-selects the item, copies the item, pastes the item, or moves the item.

8. The microphone array device of claim 7, wherein the voice signal is an ‘accept’, ‘reject’, ‘yes’, ‘no’, ‘cancel’, ‘back’, ‘next, ‘increase’, ‘decrease’, ‘up’, ‘down’, ‘stop’, ‘play’, ‘pause’, ‘copy’, ‘cut’, or ‘paste’.

9. The microphone array device of claim 1, wherein the microphone array comprises at least one transmitting element that transmits an ultrasonic signal, and the controller element identifies the finger movement from a relative phase and time of flight of a reflection of the ultrasonic pulse off the finger.

10. A storage medium, comprising computer instructions for:
tracking a finger movement in a touchless sensory field of a microphone array;
processing a voice signal received at the microphone array associated with the finger movement; and
navigating a user interface in accordance with the finger movement and the voice signal;
presenting information in the user interface according to the finger movement and the voice signal.

11. The storage medium of claim 10, comprising computer instructions for
detecting a direction of the voice signal; and
adjusting a directional sensitivity of the microphone array with respect to the direction.

12. The storage medium of claim 10, comprising computer instructions for
detecting a finger movement in the touchless sensory field; and
controlling at least one component of the user interface in accordance with the finger movement and the voice signal.

13. The storage medium of claim 10, comprising computer instructions for activating a component of the user interface selected by the finger movement, and adjusting the component in response to a voice signal.

14. The storage medium of claim 10, comprising computer instructions for overlaying a pointer in the user interface, controlling a movement of the pointer in accordance with finger movements, and presenting the information when the pointer is over an item in the display.

15. The storage medium of claim 10, comprising computer instructions for overlaying information on the user interface when the finger is at a location in the touchless sensory space that is mapped to a component in the user interface.

16. A sensing unit, comprising
a transmitter to transmit ultrasonic signals for creating a touchless sensing field;
a microphone array to capture voice signals and reflected ultrasonic signals, and
a controller operatively coupled to the transmitter and microphone array to
process the voice signals and ultrasonic signals, and
adjust at least one user interface control according to the voice signals and reflected ultrasonic signals.

17. The sensing unit of claim 16, wherein the controller element identifies a location of an object in the touchless sensory field, and adjusts a directional sensitivity of the microphone array to the location of the object.

18. The sensing unit of claim 16, wherein the controller element
identifies a location of a finger in the touchless sensory field,
maps the location to a sound source, and
suppresses or amplifies acoustic signals from the sound source that are received at the microphone array.

19. The sensing unit of claim 17, wherein the controller determines from the location when the sensing unit is hand-held for speaker-phone mode and when the sensing unit is held in an ear-piece mode.

20. The sensing unit of claim 17 is communicatively coupled to a cell phone, a headset, a portable music player, a laptop, or a computer.
